(19) United States
(12) Patent Application Publication
(10) Pub. No.: US 2023/0306078 A1
(43) Pub. Date: Sep. 28, 2023

(54) DESIGNING A FAIR MACHINE LEARNING MODEL THROUGH USER INTERACTION

(71) Applicant: International Business Machines Corporation, Armonk, NY (US)

(72) Inventors: Oznur Alkan, Dublin (IE); Elizabeth Daly, Dublin (IE); Karthikeyan Natesan Ramamurthy, Pleasantville, NY (US); Skyler SPEAKMAN, Nairobi (KE)

(21) Appl. No.: 17/655,803

(22) Filed: Mar. 22, 2022

(51) Int. Cl. G06K 9/62

(52) U.S. Cl. CPC G06K 9/6257; G06K 9/6263; G06K 9/6231

(57) ABSTRACT

A computer-implemented method, a computer program product, and a computer system for designing a fair machine learning model through user interaction. A computer system receives from a user a request for reviewing one or more biased subgroups in a dataset used in training a machine learning model and presents to the user the one or more biased subgroups and respective bias scores thereof. A computer system preprocesses the dataset to mitigate bias, in response to receiving from the user a request for mitigating the bias associated with the one or more biased subgroups. A computer system retrains the machine learning model, using a new dataset obtained from preprocessing the dataset. A computer system presents to the user respective new bias scores of the one or more biased subgroups in the new dataset. The user reviews the respective new bias scores to determine whether the fair machine learning model is built.

### BACKGROUND

The present invention relates generally to machine learning, and more particularly to designing a fair machine learning model through user interaction.

Bias may exist in subsets of a dataset that is used for training a machine learning model, and this bias in the subsets results in the machine learning model that in turn is biased. State of the art techniques exist for detecting such subsets in the dataset. In such subsets, certain cohorts based on certain characteristics may have their predicted probability of a certain subset that differs from the observed probability of a similar subset of records.

### SUMMARY

In one aspect, a computer-implemented method for designing a fair machine learning model through user interaction is provided. The computer-implemented method includes receiving, from a user, a request for reviewing one or more biased subgroups in a dataset used in training a machine learning model. The computer-implemented method further includes presenting to the user the one or more biased subgroups and respective bias scores thereof. The computer-implemented method further includes, in response to receiving from the user a request for mitigating bias associated with the one or more biased subgroups, preprocessing the dataset to mitigate the bias. The computer-implemented method further includes retraining the machine learning model, using a new dataset obtained from preprocessing the dataset. The computer-implemented method further includes presenting to the user respective new bias scores of the one or more biased subgroups in the new dataset, where the user reviews the respective new bias scores to determine whether the fair machine learning model is built.

In another aspect, a computer program product for designing a fair machine learning model through user interaction is provided. The computer program product comprises a computer readable storage medium having program instructions embodied therewith, and the program instructions are executable by one or more processors. The program instructions are executable to: receive, from a user, a request for reviewing one or more biased subgroups in a dataset used in training a machine learning model; present to the user the one or more biased subgroups and respective bias scores thereof; in response to receiving from the user a request for mitigating bias associated with the one or more biased subgroups, preprocess the dataset to mitigate the bias; retrain the machine learning model, using a new dataset obtained from preprocessing the dataset; present to the user respective new bias scores of the one or more biased subgroups in the new dataset; and wherein the user reviews the respective new bias scores to determine whether the fair machine learning model is built.

In yet another aspect, a computer system for designing a fair machine learning model through user interaction is provided. The computer system comprises one or more processors, one or more computer readable tangible storage devices, and program instructions stored on at least one of the one or more computer readable tangible storage devices for execution by at least one of the one or more processors. The program instructions are executable to receive, from a user, a request for reviewing one or more biased subgroups in a dataset used in training a machine learning model. The program instructions are further executable to present to the user the one or more biased subgroups and respective bias scores thereof. The program instructions are further executable to, in response to receiving from the user a request for mitigating bias associated with the one or more biased subgroups, preprocess the dataset to mitigate the bias. The program instructions are further executable to retrain the machine learning model, using a new dataset obtained from preprocessing the dataset. The program instructions are further executable to present to the user respective new bias scores of the one or more biased subgroups in the new dataset, where the user reviews the respective new bias scores to determine whether the fair machine learning model is built.

### BRIEF DESCRIPTION OF THE SEVERAL VIEWS OF THE DRAWINGS

FIG. 1 is a systematic diagram illustrating a system for designing a fair machine learning model through user interaction, in accordance with one embodiment of the present invention.

FIG. 2 is a flowchart showing operational steps of designing a fair machine learning model through user interaction, in accordance with one embodiment of the present invention.

FIG. 3 is a diagram illustrating components of a computing device or server, in accordance with one embodiment of the present invention.

FIG. 4 depicts a cloud computing environment, in accordance with one embodiment of the present invention.

FIG. 5 depicts abstraction model layers in a cloud computing environment, in accordance with one embodiment of the present invention.

### DETAILED DESCRIPTION

Embodiments of the present invention disclose a system for designing a fair machine learning model through user interaction. Embodiments of the present invention leverage methods of detecting dataset bias along with a data augmentation algorithm in order to support a user in the loop mitigation of such biases in a trained machine learning model. Embodiments of the present invention leveraging an artificial intelligence (AI) solution in high stakes decision making.

For example, let us consider a scenario where a company wants to use a loan approval system to approve or disapprove loan applications. The loan approval system is expected to help with the decision making process. The loan approval system needs to take into account frequently changing business rules and regulations. The company wants to ensure that the loan approval system is fair among sub-populations regarding the approvals for the loan applications. To design a fair loan approval system that can help with the decision making process, embodiments of the present invention detect biased subgroups, allows user to select which subgroup(s) should be considered for bias mitigation based on presented bias scores and active business rules and regulations, and mitigates bias for the selected subgroups through preprocessing the dataset.

Embodiments of the present invention include a method of automatically detecting all the subgroups that are biased. Embodiments of the present invention include a method of automatically preprocessing the dataset to mitigate bias for the user-approved subgroups. Embodiments of the present invention include components to manage the interaction between a user and a system for designing a fair machine learning model through user interaction. Embodiments of the present invention include components to automatically perform updates on the machine learning model as controlled by the user.

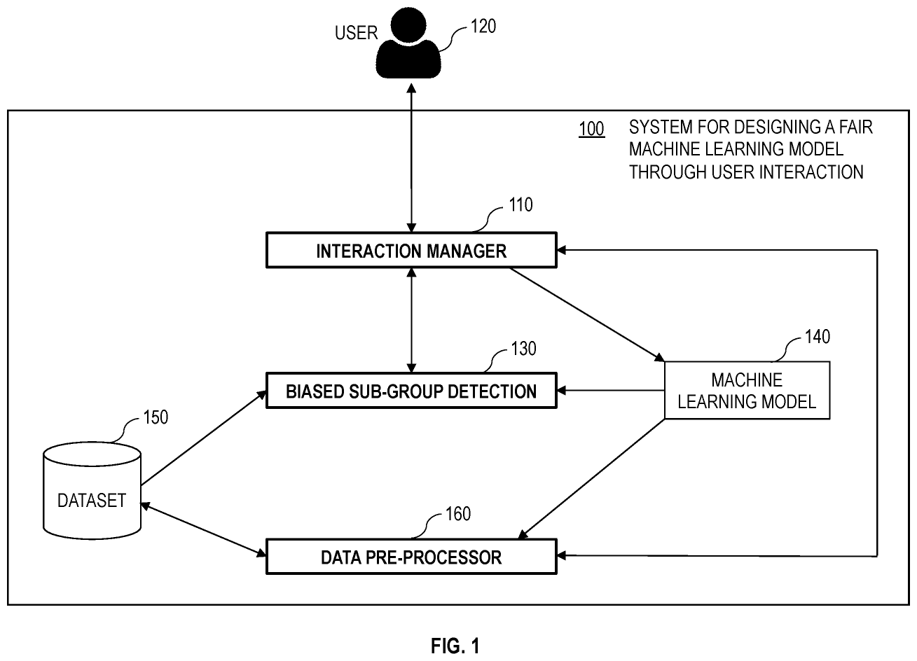

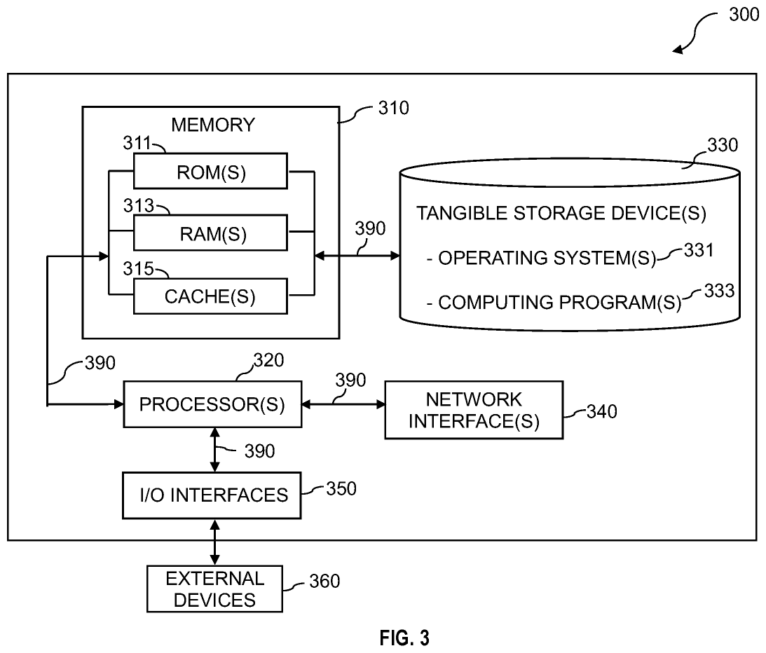

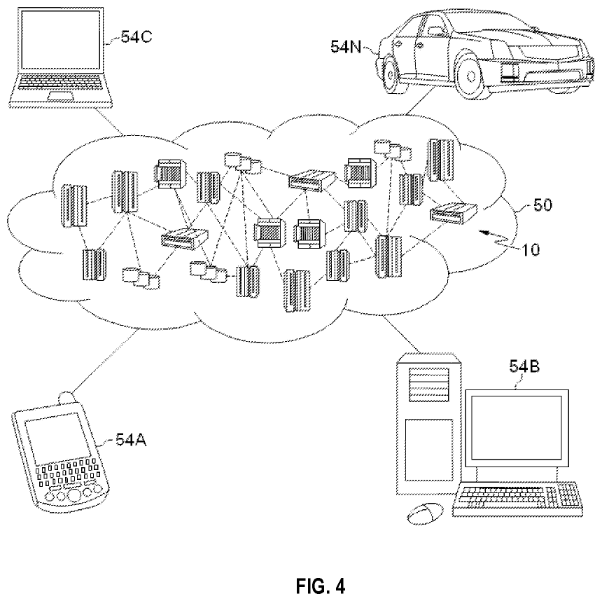

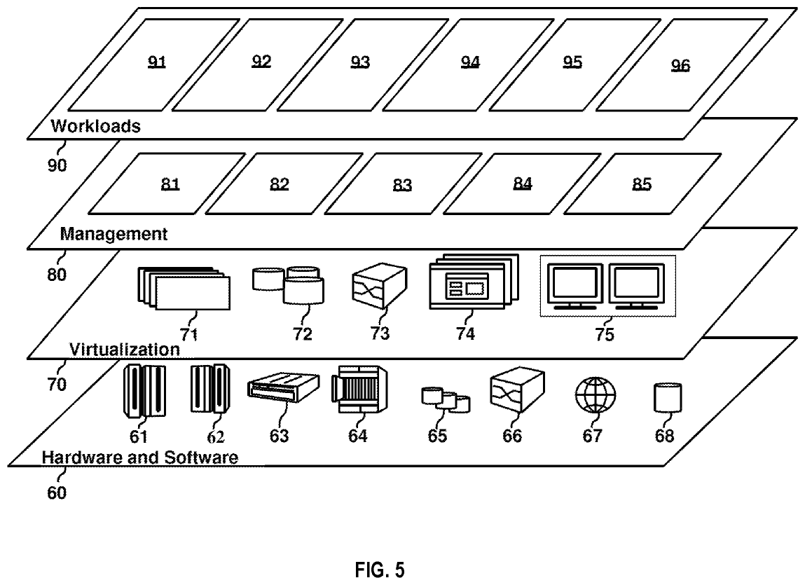

FIG. 1 is a systematic diagram illustrating system 100 for designing a fair machine learning model through user interaction, in accordance with one embodiment of the present invention. System 100 for designing a fair machine learning model through user interaction is implemented on one or more servers. A server is described in more detail in later paragraphs with reference to FIG. 3. System 100 may be implemented in a cloud computing environment. The cloud computing environment is described in more detail in later paragraphs with reference to FIG. 4 and FIG. 5.

System 100 includes interaction manager 110. Interaction between interaction manager 110 and user 120 may take place through an interactive user interface (UI) or a chatbot. Interaction manager 110 presents to user 120 different performance metrics and presents biased subgroups if they exist. User 120 is a domain expert who views biased subgroups in the form of Boolean rules and bias scores. User 120 decides whether to allow system 100 to mitigate the bias or complete the model building process. User 120 edits a list of presented biased subgroups, such as including a subgroup, excluding a subgroup, or updating the presented subgroup via editing Boolean rules that are used to present subgroups. Through interaction manager 110, user 120 requests system 100 to preprocess dataset 150 to mitigate bias for selected subgroups. For example, the user interface layer can be achieved through using IBM Watson Assistant to build a conversational interaction environment (e.g., a chatbot) which enables user 120 and interaction manager 110 to communicate and achieve the functionalities specified as above. Interaction manager 110 may call application programming interfaces (APIs) of machine learning model 140 to retrain machine learning model 140, and interaction manager 110 displays the model performance scores accordingly.

System 100 further includes biased sub-group detection component 130. Biased sub-group detection component 130 takes the following as inputs: dataset 150, machine learning model 140, and possible protected variables of the domain which can lead to bias; then, biased sub-group detection component 130 automatically outputs biased subgroups and bias scores associated with the biased subgroups.

System 100 further includes data pre-processor 160. Data pre-processor 160 takes the following as inputs: dataset 150, machine learning model 140, and a set of Boolean rules; then data pre-processor 160 updates and augments dataset 150. Therefore, once machine learning model 140 is retrained on new dataset 150, decision boundaries of machine learning model 140 will change based on the rules provided as input. While implementing augmentation of dataset 150, data pre-processor 160 makes the bias scores associated with the biased subgroups to be minimized.

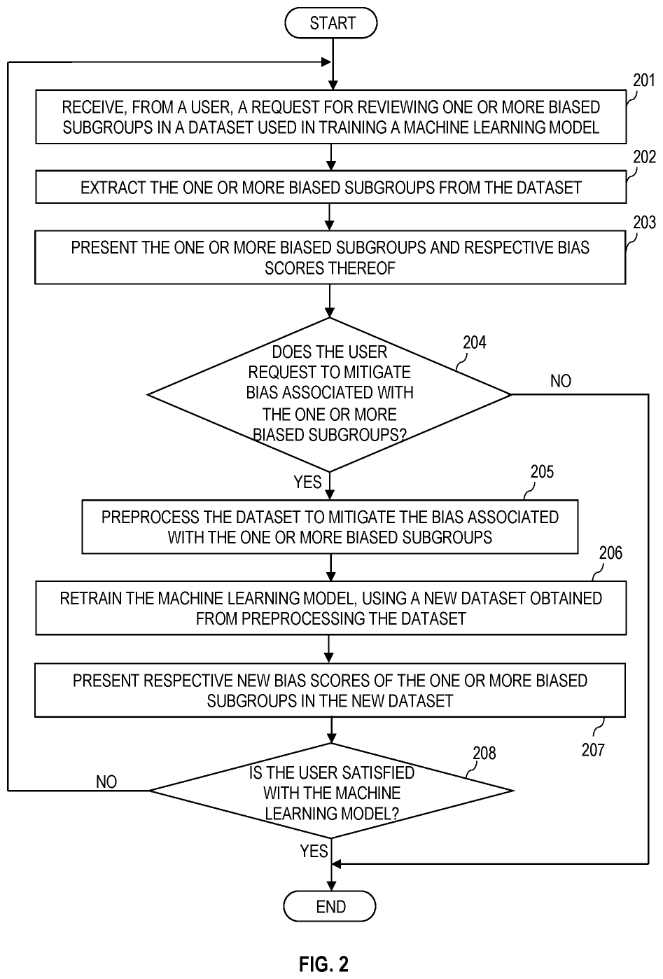

FIG. 2 is a flowchart showing operational steps of designing a fair machine learning model through user interaction, in accordance with one embodiment of the present invention. The operational steps are implemented on one or more computing devices or servers. A server is described in more detail in later paragraphs with reference to FIG. 3. The operational steps may be implemented in a cloud computing environment. The cloud computing environment is described in more detail in later paragraphs with reference to FIG. 4 and FIG. 5.

At step 201, the one or more computing devices or servers receive, from a user, a request for reviewing one or more biased subgroups in a dataset used in training a machine learning model. The user aims to build a machine learning model which is fair based on the application domain. For example, in the embodiment shown in FIG. 1, interaction manager 110 receives, from user 120, a request for reviewing one or more biased subgroups in dataset 150 which is used for training machine learning model 140.

At step 202, the one or more computing devices or servers extract the one or more biased subgroups from the dataset. The one or more computing devices or servers also calculate respective bias scores of the one or more biased subgroups. For example, in the embodiment shown in FIG. 1, interaction manager 110 calls biased sub-group detection component 130 to extract the one or more biased subgroups from dataset 150 and calculates the respective bias scores.

In response to determining that the one or more biased subgroups exist in the dataset, at step 203, the one or more computing devices or servers present the one or more biased subgroups and respective bias scores thereof. The one or more computing devices or servers present the one or more biased subgroups in the form of Boolean rules or predicates. For example, in the embodiment shown in FIG. 1, interaction manager 110 presents to user 120 the one or more biased subgroups and the respective bias scores.

At step 204, the one or more computing devices or servers determine whether the user requests to mitigate bias associated with the one or more biased subgroups. Upon reviewing the one or more biased subgroups and the respective bias scores which are presented at step 203, the user decides whether to approve the mitigation by the one or more computing devices or servers. For example, in the embodiment shown in FIG. 1, interaction manager 110 determines whether user 120 requests the mitigation.

In response to determining that the user requests to mitigate the bias or the user approves the mitigation (YES branch of decision block 204), at step 205, the one or more computing devices or servers preprocess the dataset to mitigate the bias associated with the one or more biased subgroups. For example, in the embodiment shown in FIG. 1, upon receiving the request or the approval from user 120, interaction manager 110 calls biased sub-group detection component 130 to preprocess dataset 150. In response to determining that the user does not request to mitigate the bias or the user does not approve the mitigation (NO branch of decision block 204), the one or more computing devices or servers terminate the operational steps.

At step 206, the one or more computing devices or servers retrain the machine learning model, using a new dataset obtained from preprocessing the dataset. For example, in the embodiment shown in FIG. 1, interaction manager 110 calls APIs of machine learning model 140 to retrain machine learning model 140. Machine learning model 140 is retrained by using new dataset 150 that is preprocessed by biased sub-group detection component 130.

At step 207, the one or more computing devices or servers present respective new bias scores of the one or more biased subgroups in the new dataset. The respective new bias scores of the one or more biased subgroups are calculated based on performance of the retrained machine learning model using the new dataset. For example, in the embodiment shown in FIG. 1, interaction manager 110 calls biased sub-group detection component 130 to calculate the respective new bias scores and presents to user 120 the respective new bias scores.

After preprocessing the dataset at step 205, the performance of the machine learning model is improved, because of using the new dataset to retrain the machine learning model. The respective new bias scores show that the bias associated with the one or more biased subgroups is minimized.

At step 208, the one or more computing devices or servers determine whether the user is satisfied with the machine learning model. The machine learning model has been retrained at step 206 with the new dataset obtained from preprocessing at step 205. For example, in the embodiment shown in FIG. 1, user 120 reviews the respective new bias scores presented by interaction manager 110. Based on the respective new bias scores, user 120 determines whether the fair machine learning model is built, and user 120 notifies interaction manager 110 whether user 120 is satisfied with the machine learning model retrained by the new dataset (which is obtained by preprocessing).

In response to determining that the user is satisfied with the machine learning model or receiving from the user a notification of satisfaction with the machine learning model (YES branch of decision block 208), the one or more computing devices or servers terminate the operational step. So far, a fair machine learning model is provided to the user by the one or more computing devices or servers. In response to determining that the user is not satisfied with the machine learning model or receiving from the user a notification of unsatisfaction with the machine learning model (NO branch of decision block 208), the one or more computing devices or servers iterate step 201; the user may send the one or more computing devices or servers another request in order to build a fair machine learning model.

FIG. 3 is a diagram illustrating components of computing device or server 300, in accordance with one embodiment of the present invention. It should be appreciated that FIG. 3 provides only an illustration of one implementation and does not imply any limitations; different embodiments may be implemented.

Referring to FIG. 3, computing device or server 300 includes processor(s) 320, memory 310, and tangible storage device(s) 330. In FIG. 3, communications among the above-mentioned components of computing device or server 300 are denoted by numeral 390. Memory 310 includes ROM(s) (Read Only Memory) 311, RAM(s) (Random Access Memory) 313, and cache(s) 315. One or more operating systems 331 and one or more computer programs 333 reside on one or more computer readable tangible storage device(s) 330.

Computing device or server 300 further includes I/O interface(s) 350. I/O interface(s) 350 allows for input and output of data with external device(s) 360 that may be connected to computing device or server 300. Computing device or server 300 further includes network interface(s) 340 for communications between computing device or server 300 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of designing a fair machine learning model through user interaction.

What is claimed is:

1. A computer-implemented method for designing a fair machine learning model through user interaction, the method comprising:
receiving, from a user, a request for reviewing one or more biased subgroups in a dataset used in training a machine learning model;
presenting to the user the one or more biased subgroups and respective bias scores thereof;
in response to receiving from the user a request for mitigating bias associated with the one or more biased subgroups, preprocessing the dataset to mitigate the bias;
retraining the machine learning model, using a new dataset obtained from preprocessing the dataset;
presenting to the user respective new bias scores of the one or more biased subgroups in the new dataset; and
wherein the user reviews the respective new bias scores to determine whether the fair machine learning model is built.

2. The computer-implemented method of claim 1, further comprising:
receiving from the user a notification that the user is satisfied with the machine learning model which is retrained with the new dataset.

3. The computer-implemented method of claim 1, further comprising:
extracting the one or more biased subgroups from the dataset; and
calculating the respective bias scores of the one or more biased subgroups.

4. The computer-implemented method of claim 1, further comprising:
calculating the respective new bias scores of the one or more biased subgroups, after retraining the machine learning model with the new dataset.

5. The computer-implemented method of claim 1, further comprising:
inputting the dataset, the machine learning model, and possible protected variables of a domain which leads to the bias; and
outputting the one or more biased subgroups and the respective bias scores.

6. The computer-implemented method of claim 1, further comprising:
inputting the dataset, the machine learning model, and one or more biased subgroups in a form of Boolean rules; and
updating and augmenting the dataset.

7. The computer-implemented method of claim 1, further comprising:
calling an application programming interface of the machine learning model to retrain the machine learning model.

8. A computer program product for designing a fair machine learning model through user interaction, the computer program product comprising a computer readable storage medium having program instructions embodied therewith, the program instructions executable by one or more processors, the program instructions executable to:
receive, from a user, a request for reviewing one or more biased subgroups in a dataset used in training a machine learning model;
present to the user the one or more biased subgroups and respective bias scores thereof;
in response to receiving from the user a request for mitigating bias associated with the one or more biased subgroups, preprocess the dataset to mitigate the bias;
retrain the machine learning model, using a new dataset obtained from preprocessing the dataset;
present to the user respective new bias scores of the one or more biased subgroups in the new dataset; and
wherein the user reviews the respective new bias scores to determine whether the fair machine learning model is built.

9. The computer program product of claim 8, further comprising the program instructions executable to:
receive from the user a notification that the user is satisfied with the machine learning model which is retrained with the new dataset.

10. The computer program product of claim 8, further comprising the program instructions executable to:
extract the one or more biased subgroups from the dataset; and
calculate the respective bias scores of the one or more biased subgroups.

11. The computer program product of claim 8, further comprising the program instructions executable to:
calculate the respective new bias scores of the one or more biased subgroups, after retraining the machine learning model with the new dataset.

12. The computer program product of claim 8, further comprising the program instructions executable to:
input the dataset, the machine learning model, and possible protected variables of a domain which leads to the bias; and
output the one or more biased subgroups and the respective bias scores.

13. The computer program product of claim 8, further comprising program instructions executable to:
input the dataset, the machine learning model, and one or more biased subgroups in a form of Boolean rules; and
update and augment the dataset.

14. The computer program product of claim 8, further comprising the program instructions executable to:
call an application programming interface of the machine learning model to retrain the machine learning model.

15. A computer system for designing a fair machine learning model through user interaction, the computer system comprising one or more processors, one or more computer readable tangible storage devices, and program instructions stored on at least one of the one or more computer readable tangible storage devices for execution by at least one of the one or more processors, the program instructions executable to:
receive, from a user, a request for reviewing one or more biased subgroups in a dataset used in training a machine learning model;
present to the user the one or more biased subgroups and respective bias scores thereof;
in response to receiving from the user a request for mitigating bias associated with the one or more biased subgroups, preprocess the dataset to mitigate the bias;
retrain the machine learning model, using a new dataset obtained from preprocessing the dataset;
present to the user respective new bias scores of the one or more biased subgroups in the new dataset; and
wherein the user reviews the respective new bias scores to determine whether the fair machine learning model is built.

16. The computer system of claim 15, further comprising the program instructions executable to:
receive from the user a notification that the user is satisfied with the machine learning model which is retrained with the new dataset.

17. The computer system of claim 15, further comprising the program instructions executable to:
extract the one or more biased subgroups from the dataset; and
calculate the respective bias scores of the one or more biased subgroups.

18. The computer system of claim 15, further comprising the program instructions executable to:
calculate the respective new bias scores of the one or more biased subgroups, after retraining the machine learning model with the new dataset.

19. The computer system of claim 15, further comprising the program instructions executable to:
input the dataset, the machine learning model, and possible protected variables of a domain which leads to the bias; and
output the one or more biased subgroups and the respective bias scores.

20. The computer system of claim 15, further comprising program instructions executable to:
input the dataset, the machine learning model, and one or more biased subgroups in a form of Boolean rules; and
update and augment the dataset.
